(19) United States
(12) Patent Application Publication
(10) Pub. No.: US 2008/0046464 A1
(43) Pub. Date: Feb. 21, 2008

(54) Apparatus And Method For Storing And Distributing Information In An Emergency Situation

(75) Inventor: Sven Eric Gustavsson, Stockholm (SE)

Correspondence Address: THOMPSON & KNIGHT, L.L.P.;PATENT PROSECUTION GROUP, 1700 PACIFIC AVENUE, SUITE 3300, DALLAS, TX, 75201, US

(73) Assignee: FIRST AID CARD ENTERPRISES AB, Eskilstuna (SE)

(21) Appl. No.: 10/586,122

(22) PCT Filed: Jan. 17, 2005
(86) PCT No.: PCT/SE05/00036

§ 371 Date: Sep. 6, 2007

Related U.S. Application Data
(60) Provisional application No. 60/481,902, filed on Jan. 16, 2004.

(30) Foreign Application Priority Data
Jan. 16, 2004 (SE) 0400084-0

(51) Int. Cl. G06F 17/00

(52) U.S. Cl. 707/104.1; 707/E17.005

(57) ABSTRACT

The present invention relates to an apparatus and method for storage and distribution of individualised information concerning specific treatments, desires and identification in case of an emergency situation, comprising a first database (60), which is accessed by individuals from communication terminals (50), the individuals inputting or updating their own personalised information thereon, the first database including both identities and personalised information. A second database (70) is provided for communication with at least one mobile communication terminal (80), the terminal having reading means (not shown) adapted to determine and communicate to the second database the identity of a transponder (90) carried by an individual. Moreover, the second database is adapted to match the identity of the transponder to the personalised information retrieved from the first database. The invention is characterised in that personalised information and identification is provided to and is displayed on the mobile communication terminal so as to assist personnel during an accident, medical or emergency situation.

### TECHNICAL FIELD OF THE INVENTION

The present invention relates to an apparatus, method and computer program for identification of individuals, storage and distribution of individualised information concerning specific treatments, desires and identification in case of an emergency situation, wherein databases containing predetermined personalised information are adapted to match a provided identity with the personalised information so as to assist personnel during an accident, medical or emergency situation.

### BACKGROUND OF THE INVENTION

A large number of ideas are currently available generally relating to the need for emergency medical staff, physicians and paramedics to be informed about the needs of their patients. Various means are used today in order to provide them and family members of patients with information regarding their health history and, if applicable, specific medical desires of patients. Some people who suffer from chronic illnesses, such as haemophilia, epilepsy or extreme allergy wear bracelets, necklaces, badges or wristwatches that symbolise a specific chronic disease. These people may need special attention or be given priority to by paramedics during an emergency situation. However, many people who suffer from one of the above illnesses may not want to display this fact publicly, and therefore they often tend to refuse wearing the symbolising necklace or badge for instance.

In addition to that, a large number of people carry discreet paper notes in their wallets or purses with medical information. The medical information may be combined with information regarding their willingness or ability to donate organs or tissue for transplantation or medical purposes, possibly with specific limitations. That is an alternative way of displaying needs for specific treatments and individual desires in case of an emergency situation. However, a discreet paper note can be difficult to find if it even does exist.

When paramedics or emergency medical staff arrive at a person who has been involved in an accident or an emergency situation, the medical staff must act quickly and without much hesitation. It is crucial that the staff quickly determines a correct diagnosis and applies appropriate treatment in order to minimise injuries or even save lives. In particular, that may be the case when a person is either unconscious or has difficulty in communicating their physical condition. Sometimes even basic medical treatment can be difficult in such a situation. If emergency information and medical history were readily available and easily accessible during a majority of accidents, not the least on the road at the scene of a traffic accident or at home during a residential emergency, responding medical staff would be able to give appropriate treatment with enhanced certainty to persons involved in accidents. The result of such available information would be minimised consequences of accidents and more lives saved.

Moreover, during a medical emergency, medical staff is sent to the accidental scene immediately after an emergency call has been made. Even if the information about identities and specific requirements of people involved in the accident could be available, the emergency medical staff does not have the time to wait for information to be gathered about a possibly involved person's medical history or current medical condition. However, establishing a correct diagnosis and applying the appropriate treatment is essential, but it requires the emergency medical staff to know whether the patient suffers from any chronic illnesses, whether the patient has any allergies, and other relevant information in the patient's medical history. As important as knowledge about any illnesses, is the opposite knowledge that a patient is entirely healthy, so as to be able to treat the patient without limitations and without any risk for mistreatment. A further complication is that the patient himself or herself often is incapacitated and cannot communicate information about the his or her medical history to the emergency medical staff, or to the person who makes the emergency telephone call, a person who usually has little or no medical training.

Hence, there is no doubt a continuing need for collecting, storing and making valuable and correct information including identification of an injured person readily available to medical staff, emergency personnel and others in case of an accident, emergency or other related medical situation.

### SUMMARY OF THE INVENTION

The object of the present inventions is to achieve this aim, and simultaneously alleviate at least some of the drawbacks and shortcomings of prior art in the same technical field.

The object is accomplished by means of an apparatus and method for storage and distribution of individualised information concerning specific treatments, desires and identification in case of an emergency situation, comprising

a first database, preferably a web-interfaced database, which is accessed by individuals from communication terminals, the individuals inputting or updating their own personalised information thereon, the first database including both identities and personalised information,

a second database, being adapted to retrieve information from the first database, which second database is in communication with at least one mobile communication terminal, the terminal having reading means adapted to determine and communicate to the second database the identity of a transponder carried by an individual,

the second database being adapted to match the identity of the transponder provided by the mobile communication terminal to the personalised information retrieved from the first database,

characterised in that

personalised information and identification, preferably in the form of both images and text, is provided to and is displayed on the mobile communication terminal so as to assist personnel during an accident, medical or emergency situation.

The first and second databases could be either separate databases or instances or parts of the same database. This is a constructional variety that is to be determined by the skilled person in database management in accordance with the requirements of the particular application under consideration. An advantage of the present invention is that it provides rapid access for paramedics, physicians and emergency medical staff after an emergency call to a person's current medical information and identification, both in the form of images and text in emergency situations and other kinds of medical or accidental situations.

Another advantage of the present invention is that it uses already available storage and/or communication means, such as mobile phones and facilities for mobile communication. These facilities in combination with a database arrangement enables distribution of necessary information. The databases contain and distribute current personal medical information that is easily identifiable when people are involved in for instance a traffic accident. Transponders to be identified could be integrally constructed with credit cards, necklaces, badges, rings etc, held be a person to be identified or treated. In various emergency response situations, such identifying devices are carried or held by the person involved in an accident and subjected to treatment, and the information can easily be found and read by emergency response or medical personnel. Moreover, conceivable reading means could be contained in vehicles or various gates to be passed when checking in an aircraft or a hotel for example.

The present invention provides involved personnel with the stored and updated medical information records that allow emergency medical personnel to faster begin appropriate medical treatment based on current medical information of incapacitated persons. Portable data storage device of communication terminal contains or at least displays current medical information specific to the person wearing the data storage device or communication terminal. A mobile communication terminal could be any kind of handheld device that accesses and displays the medical information storage means in the database arrangement. Electronic messages of any kind, such as SMS, MMS, electronic mail or other notification containing an unambiguous identity of a person. The message is then a request to retrieve information stored in records associated with the mobile communication terminal according to the invention.

A database arrangement in accordance with the present invention, is preferably in large installations associated with a number of distributed databases for coordination of the medical information records on a regional, national or international scale. The arrangement also includes the ability for any user, who has proven his identity when correctly logging on to the system, to update his or her own personal medical records. This ensures that the records contain current personal medical information, and the information is either retrievable by communication terminals or is transmitted in order to record the medical information on the portable data storage device associated with terminals.

The present invention will be most appreciated by skilled persons in the art, for its ability to be used for collecting information and information updates from users. The information will be distributed on request via a storage database in association with a mobile communication terminal to emergency personnel in order to assist them in better handling emergency situations in a fast, efficient and appropriate manner.

### BRIEF DESCRIPTION OF THE DRAWINGS

The above and further features, advantages and benefits of the present invention will be apparent upon consideration of the following detailed description, taken in conjunction with the accompanying drawings, in which like reference characters and figures refer to like parts throughout, and in which:

FIG. 1 illustrates a schematic view of the apparatus in accordance with the present invention.

FIG. 2 is a flowchart depicting the method for updating and transmitting information sequentially according to the invention.

FIG. 3 is a flowchart that depicts the display and distribution of information in accordance with the present invention.

FIG. 4 depicts an apparatus in accordance with a second embodiment of the present invention.

FIG. 5 is a flowchart of the functionality of the second embodiment according to the present invention.

### DETAILED DESCRIPTION OF EMBODIMENTS

The following description is of the best mode presently contemplated for practising the invention. The description is not to be taken in a limiting sense, but is made merely for the purpose of describing the general principles of the invention. The scope of the invention should be ascertained with reference to the issued claims.

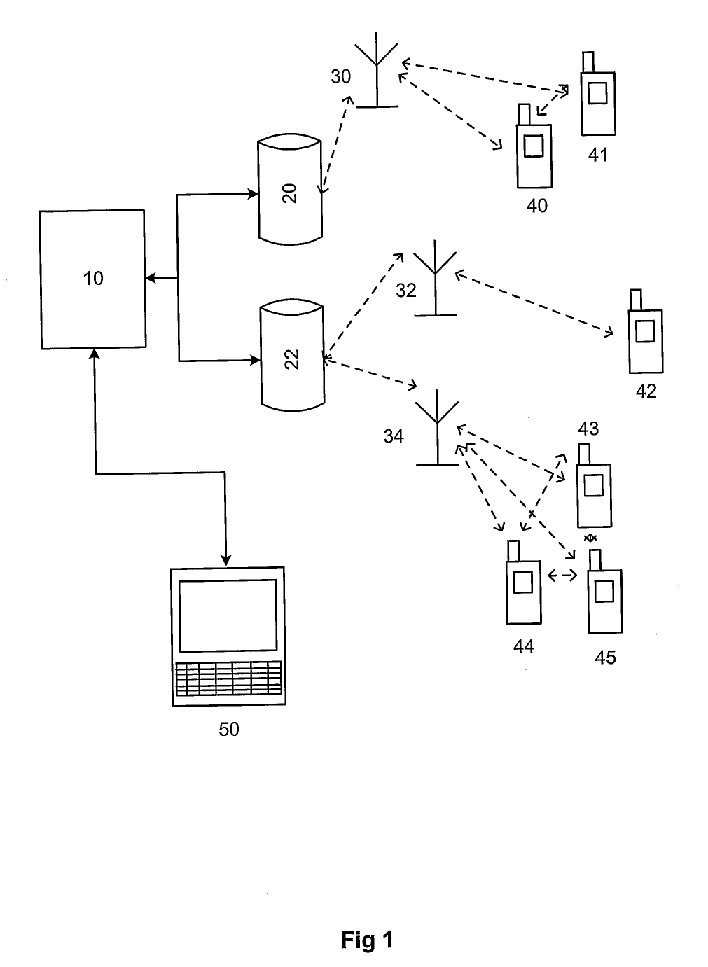

FIG. 1 illustrates a schematic view of the apparatus in accordance with the present invention. A central storage server or distributed database system 10 is able to communicate with either or both of distributed databases 20, 22 and external computer terminals 50. The external computers terminals access a certain storage space with information to be input or updated, provided that the users authorise and authenticate themselves correctly. Connection is made via the Internet or any other global interconnecting network via connecting links. Conceivable links for use are various wired and wireless transmission technologies, such as wireless access technology based on infrared, Bluetooth or wireless-LAN.

Connection means and methods used in association with the present invention will of course develop with new and emerging access technologies. The distributed databases are bi-directionally connected with radio base stations 30, 32, 34 communicating directly with a number of mobile communication terminals 40-45. Moreover, the mobile communication terminals may communicate internally on peer-to-peer basis via radio frequency or other transmission technologies. This approach may be useful, especially in poor conditions for radio transmission, so as to provide sufficient conditions for transmission of phone calls when transmission is crucial, i.e. when an accident has occurred. The basis may also be used also in other situations, such as for receiving status about a medical condition for a certain passenger on a flight.

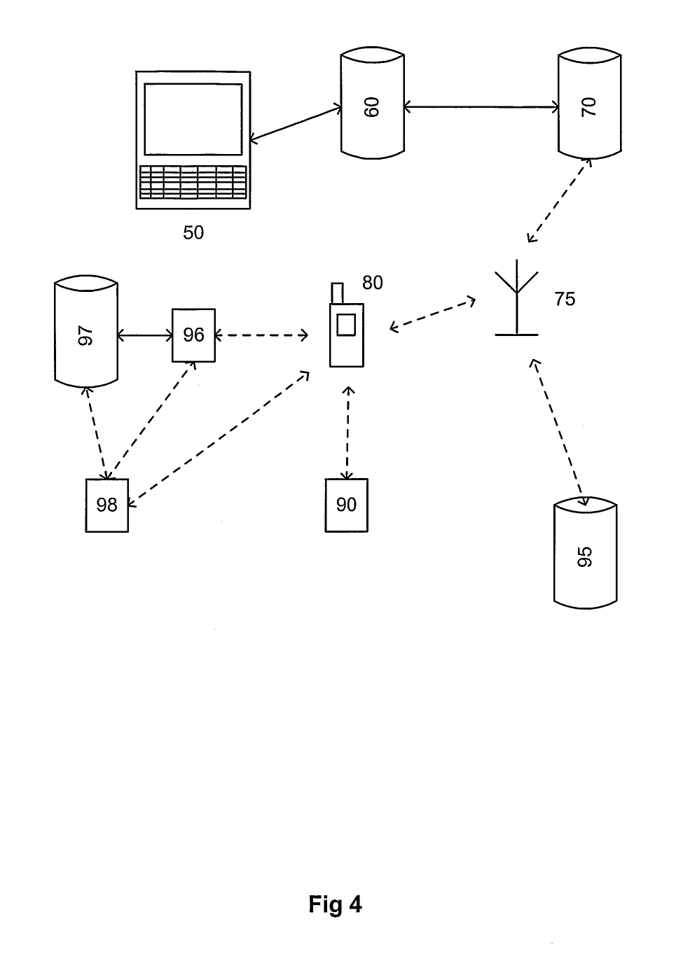

In accordance with one embodiment of the invention medical staff transmits collected emergency information to the database 95, and reference is made to FIG. 1 in conjunction with FIG. 4. The database may be operated by any host. Also a user of a mobile communication terminal may transmit the emergency information to a central storage, the software optionally transmits the gathered information wirelessly via a mobile communication network or through the Internet or a direct modem connection with the mentioned database. In an alternate embodiment, software generates a file which may be transmitted as an electronic mail attachment to the central storage. Data could be updated and sent to the database manually or automatically, i.e. at regular intervals.

The emergency personnel would obtain the emergency information stored in the storage means of for instance the mobile communication terminal, possibly by using a handheld computer or by using a so-called smart phone to access the information themselves. Alternatively, the information can be obtained by accessing the information stored locally or by accessing the database or the central storage server depending on the physical database arrangement. Alternatively, information is received from the storage means of the terminal which has accessed the information stored locally or accessed the database at the central storage server. Medical staff and other people arriving at for example a traffic accident will be assisted in both identifying and sorting prioritising injured people in accordance with their actual needs, such as giving a person with a heart condition priority over a another person with similar injuries, but without the enhanced risk for having a heart attack. In addition to the previously mentioned advantages, the invention is beneficial since people without extensive medical training or education receive support and assistance in managing an accidental situation. Such assistance may in certain cases be decisive for people to have the courage to prioritise and help people in an emergency situation, since the risk for making devastating mistakes is reduced.

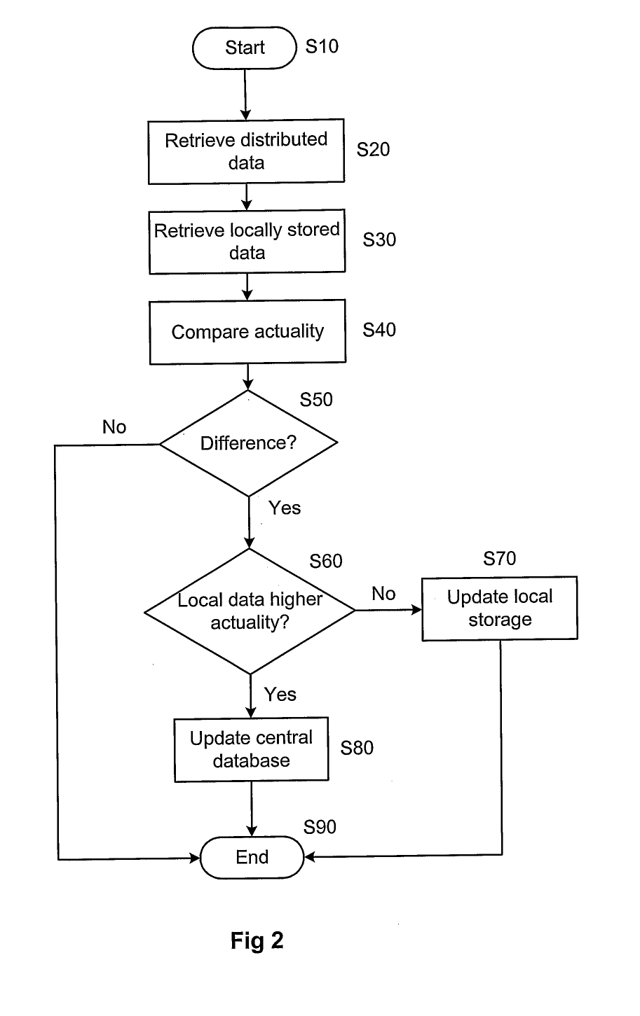

With particular reference to FIG. 2, a flowchart depicts the method for transmission of information sequentially in order to have up-to-date information stored. The method starts (S10) in that the information content of distributed databases or alternatively from the central storage database 10 is retrieved (S20) and so is locally stored information (S30). The actuality of information is compared (S40) with that of the mobile communication terminal 40-45 and distributed databases 20, 22 at regular intervals or as a result of a user initiative. Comparison utilising the respective time stamps of information content is a conceivable way of measuring the actuality. The comparison is made by means of state of the art mobile telecommunication technology via the radio base stations, through which the mobile communication terminals communicate with the central and distributed data bases. If different versions exist (S50), the information is updated (S60) so as to have the last version stored in the central storage database (S80) or in a local storage database (S70). Otherwise, the sequence continues and ends (S90), whereby a new sequence may begin on user command or at regular or user influenced intervals.

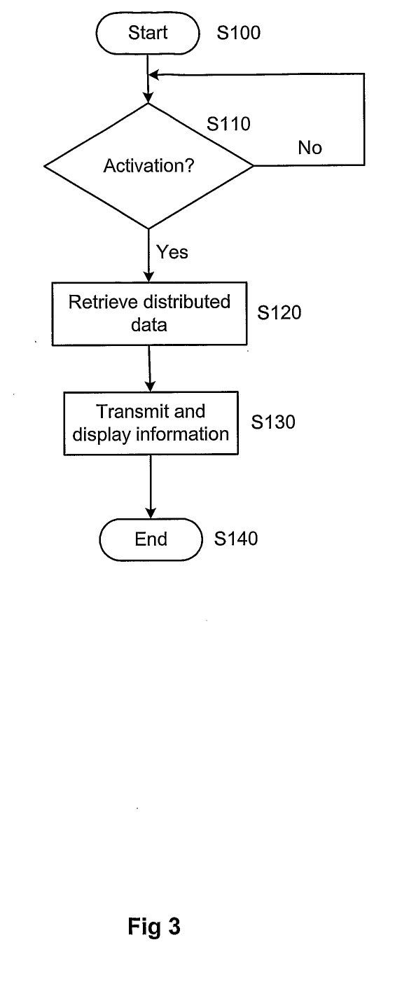

With reference to FIG. 3, a sequence for displaying and distributing information is depicted. The sequence begins (S100) in that an inquiry is made whether the activation (S10) has been made, either on user command, or resulting from an activation of a triggering means or even at regular intervals. In case no activation has been made, the sequence returns, and otherwise, an up-to-date version of data is retrieved (S120), conceivably from a distributed database. The retrieval is followed by transmission and distribution (S130) of relevant information via any means for transmission, such as the mobile communication network, a wired network, peer-to-peer or infrared to all associated terminals. Moreover, the information is displayed (S130) on a display of the mobile communication terminal. After having distributed and displayed for a predetermined period of time, the sequence may returns to comparing actuality (S40) in FIG. 2, and in association to that collecting, displaying and transmitting information to the distributed or central storage server. This ends the sequence (S140). A request is activated on user command, for instance by the triggering means, possibly a button, menu input or automatically as a result of activation of at least one accelerometer or gyroscopic means.

The step of collecting and transmitting the information could be made in a variety of ways. For example, in one embodiment, the user fills out a form provided over a computer network such as the Internet. The fields of the form are then transmitted to a central storage server. According to another embodiment, the user types in the information directly in the mobile communication terminal, from which the information is transmitted over a mobile communication network to the central storage server.

With particular reference to FIG. 4, an arrangement is illustrated which is particularly advantageous, in which a communication terminal 50 is used for providing a first database 60 with personalised data. The first database is optimised for providing individuals with user-friendliness, and the database allows for storage of exchangeable personalised information and for simultaneous access by a large number of individuals. The second database 70 retrieves updated information from the first database, and the second database is optimised for reliability in operation and quick response, although the data contents of the two databases are essentially equivalent. The first and the second databases are separated in FIG. 4 for illustrative purposes, but the skilled person would appreciate that their functionality as well could be realised in one single database or alternatively as different instances or parts of the same database.

A mobile communication terminal 80 is adapted for allowing manual input, preferably by emergency personnel of notifications about the types and seriousness of injuries of individuals during an accident or emergency situation. These notifications are communicated over a wireless communication network including base stations 75 to a third database 95, from which related hospitals are notified in advance of the seriousness and details of an accident.

In an alternative embodiment, the mobile communication terminal 80 is mounted in a vehicle, preferably integrally. A reading means of the terminal is adapted to retrieve the identities of all passengers in the vehicle, from active or passive transponders 90 carried by the passengers. Identities are intermediately stored and ready for immediate transmission to a public service access point 96 in case of an accident. Transmission is then made of minimum set of data to the public service access point, such as position and identity of the vehicle. In addition to that transmission, a full set of data is transmitted to a service provider 98, such as the number of passengers in the vehicle, crash violence of the accident, number of airbags released, and activity of seat belt tensions. However, any obtained passive and active safety sensor related data resulting from an accident or data collected from various computer systems of the vehicle are conceivable for transmission to the service provider.

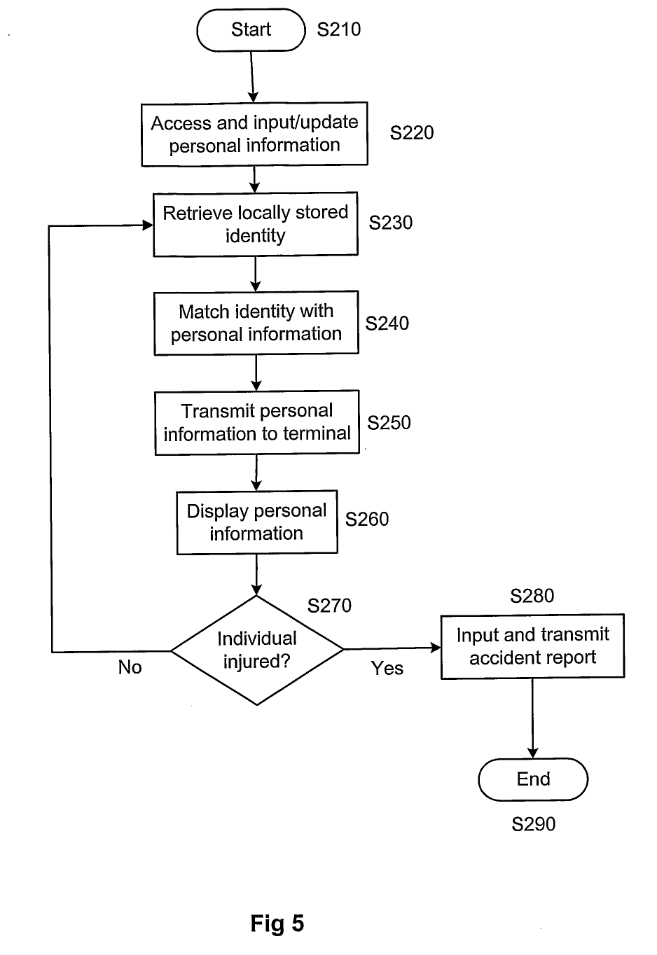

FIG. 5 illustrates a schematic diagram of the sequential operation of the database arrangement of FIG. 4. The sequence starts (S210) in that an individual accesses and updates information (S220) on the first database 60. This information is then provided to the second database 70, the so-called the accident database. In case of an accident, the identity of involved persons is provided to this database (S230). The identity is matched (S240) with personalised information contained, in particular with respect to medical conditions, predetermined desires and needs of the involved persons. This personal information is transmitted (S250) to the mobile communication terminal of assisting emergency staff and displayed (S260) thereon. For an injured person (S270), an accident report can be inputted by for instance emergency staff. The accident report is than transmitted (S280) to the third database from which related hospitals may be informed in advance so as to make the relevant and correct preparations.

Software is utilised to obtain appropriate information from users and to communicate the information to and from the central storage server. A variety of different distribution means may be utilised to distribute the software. For example, the software may be made available for download from an interconnecting global computer network such as the Internet, distributed together with new credit cards, loyalty cards and programs, mobile telephones or other consumer goods. In order to create a distinctive brand profile in the automotive industry, software that enables collection, transmission and storage of specific individualised information according to the invention can be made of in association with purchase of cars and motorcycles or other vehicles. In particular automotive brands with car safety as a strong profile will be considered in the first place.

Regardless of the method used to transmit the information, the information may be updated periodically or on a real time basis. For example, the software may include a component that automatically updates information by connecting the central storage server, either directly or via the user's Internet service provider, and sending updated files. In a further embodiment, the computer terminal of the user utilises information from other software applications, such as current status information, to automatically generate updated information files and transmit those updated information files to the central storage server. The central storage server could then access the database, find the corresponding data file, and overwrite the stored data with the updated data.

A medical information record system according to the present invention is constructed in accordance with state of the art database technology, preferably using a distributed database system. A distributed medical record database system is preferable since it is designed to provide rapid access to critical patient medical data for paramedics or other emergency personnel involved at an accident or emergency situation. The mobile communication terminal is part of the distributed medical record database system for generating, maintaining, and updating personal medical information records. Further to the mobile communication terminal, it may include means to display a person's medical information and perform identification, so as to assist medical personnel or anyone who makes an emergency telephone call.

Medical information stored in the storage means includes information such as subscriber personal identification number, subscriber name, date of birth, picture for identification, blood type, existing medical conditions, such as diabetes, epilepsy, etc, current medications, extreme sensitivities or allergies, such as nut or almond, wasp, bee, certain types of mite, birch trees, etc, allergies to medication, emergency contact phone number, physician contact number, organ donor status etc. Initial candidates for a portable data storage include elderly patients, patients with severe allergic sensitivities, epileptic patients, patients with serious heart disease, diabetic patients, etc. In the case of insurance information, also such data could be used, provided the person has given his or her consent to making use of such possibly very sensitive information.

While certain embodiments of the present invention have been shown and described it is to be understood that the present invention is subject to many modifications and changes without departing from the spirit and scope of the claims presented herein.

1. Apparatus for storage and distribution of individualised information concerning specific treatments, desires and identification in case of an emergency situation, comprising
a first database (60), preferably a web-interfaced database, which is accessed by individuals from communication terminals (50), the individuals inputting or updating their own personalised information thereon, the first database including both identities and personalised information,
a second database (70), being adapted to retrieve information from the first database, which second database is in communication with at least one mobile communication terminal (80), the terminal having reading means (not shown) adapted to determine and communicate to the second database the identity of a transponder (90) carried by an individual,
the second database being adapted to match the identity of the transponder provided by the mobile communication terminal to the personalised information retrieved from the first database,
characterised in that
personalised information and identification is provided to and is displayed on the mobile communication terminal so as to assist personnel during an accident, medical or emergency situation.

2. Apparatus according to claim 1, characterised in that the first database is optimised for provision of user-friendliness, storage of exchangeable personalised information and allowing for simultaneous access by a large number of individuals, whereas the second database is optimised for reliability in operation and quick response.

3. Apparatus according to claim 1, characterised in that the first and second databases form parts or instances of one single database.

4. Apparatus according to claim 1, characterised in that
the mobile communication terminal is adapted for manual input of notifications about the types and seriousness of injuries of individuals during an accident or emergency situation, which notifications are communicated via a third database (95) to related hospitals.

5. Apparatus according to anyone of claims 1-4, characterised in that
the mobile communication terminal is mounted in a vehicle, whereby the reading means is adapted to retrieve the identities of all passengers in the vehicle, the identities being intermediately stored and ready for immediate transmission to a public service access point (96).

6. Apparatus according to anyone of claims 1-5, characterised in that
the mobile communication terminal is adapted to transmit a minimum set of data to the public service access point, such as position and identity of the vehicle, and in parallel transmit a full set of data to a service provider (98), such as safety sensor related data or other relevant data collected from any computer system of the vehicle.

7. Apparatus according to anyone of claims 5-6, characterised in that
the mobile communication terminal is integrally mounted in the vehicle.

8. Apparatus according to anyone of claims 5-7, characterised in that
transmission of intermediately stored identities is activated by a triggering means.

9. Apparatus according to of claim 7, characterised in that
the triggering means is an accelerometer, gyro or any other related means integrated with the vehicle, which is activated by physical violence resulting from an accident.

10. Apparatus according to claim 5, characterised in that
the public service access point is adapted to retrieve vehicle related information from any connected service provider (97), such as explosive or otherwise dangerous load, presence of accident influencing elements and type of vehicle.

11. Apparatus according to anyone of claims 1-3, characterised in that
the reading means is chosen from a group comprising an RFID reader, an IMEI number reader, the IMEI number being specified in GSM/GPRS standards, Bluetooth or Wi-Fi.

12. Apparatus according to claim 1, characterised in that
the transponder being active, such as provided with a battery or other power means.

13. Apparatus according to claim 1, characterised in that
the transponder being passive, such as a thin transponder tablet or tag.

14. Apparatus according to claim 1, characterised in that
the first database, which is accessed by individuals from communication terminals, is adapted to be receive input or updates from the individuals via mobile communication terminals.

15. Apparatus according to anyone preceding claims, characterised in that
the mobile communication terminal is adapted to provide access to and retrieve information to be displayed from an existing medical record database system.

16. Apparatus according to anyone preceding claims, characterised in that
connection between mobile or stationary communication terminals and databases is established via at least one radio base station (75) used primarily for establishing connections between mobile telephones in a communication network.

17. Apparatus according to anyone of preceding claims, characterised in that
connection is established for information updates in a wireless communication network, such as wireless-LAN, so-called hotspot, wireless dial-up access service or Wi-Fi access location.

18. Apparatus according to claim 16, characterised in that
the radio base station is a communication terminal with which connection is established peer-to-peer via radio frequency transmission, such as Bluetooth, or via transmission of infrared signals.

19. Method for storing and distributing individualised information concerning specific treatments, desires and identification in case of an emergency situation, the method including the steps of:
individuals accessing a first database (60) from communication terminals (50) for inputting or updating personalised information stored on the database, the first database including both identities and personalised information,
a second database (70) retrieving information from the first database and communicating with at least one mobile communication terminal (80), the terminal having reading means (not shown) for determining and communicating to the second database the identity of a transponder (90) carried by an individual,
matching on the second database the identity of the transponder provided by the mobile communication terminal to the personalised information retrieved from the first database,
characterised by
providing to and displaying personalised information and identification on the mobile communication terminal so as to assist personnel during an accident, medical or emergency situation.

20. Method according to claim 18, characterised by
forming the first and second databases as parts or instances of one single database.

21. Computer program which when executed on a computer means is adapted to carry out the method steps of anyone of claims 19-20.
